(19) United States
(12) Patent Application Publication
(10) Pub. No.: US 2016/0244302 A1
(43) Pub. Date: Aug. 25, 2016

(54) MARINE MOTION COMPENSATED DRAW-WORKS REAL-TIME PERFORMANCE MONITORING AND PREDICTION

(71) Applicant: Transocean Sedco Forex Ventures Limited, George Town Grand Cayman (KY)

(72) Inventors: Trenton Martin, Kingwood, TX (US); Rafik Ishak Stefanos, Houston, TX (US); Aaron Barr, Houston, TX (US)

(21) Appl. No.: 15/051,411

(22) Filed: Feb. 23, 2016

Related U.S. Application Data
(60) Provisional application No. 62/119,537, filed on Feb. 23, 2015.

(51) Int. Cl. B66C 13/06; B66C 13/16; G07C 3/00; B63B 35/44

(52) U.S. Cl. CPC B66C 13/06; B63B 35/4413; B66C 13/16; G07C 3/00

(57) ABSTRACT

A method for identifying compliance of a marine motion-compensated draw-works system's performance with pre-defined performance specifications, includes the steps of: receiving, by a processor, performance data associated with a marine motion-compensated draw-works system; receiving, by the processor, pre-defined performance specifications for the draw-works system; determining, by the processor, whether or not the performance of the draw-works system complies with the pre-defined performance specifications; and outputting, by the processor, a notification when the performance of the draw-works system is determined to not be in compliance with the pre-defined performance specifications.

### CROSS-REFERENCE TO RELATED PATENT APPLICATIONS

This patent application claims the benefit of priority of U.S. Provisional Patent Application No. 62/119,537 to Martin et al. filed on Feb. 23, 2015 and entitled “MARINE MOTION COMPENSATED DRAW-WORKS REAL-TIME PERFORMANCE MONITORING AND PREDICTION,” which is hereby incorporated by reference in its entirety.

### FIELD OF THE DISCLOSURE

This disclosure relates to equipment used for drilling operations in oil and gas wells. More specifically, portions of this disclosure relates to a method of identifying the performance of marine motion compensated draw-works in real-time or predicted.

### BACKGROUND

The active heave draw-works or other draw-works with active motion compensation provides some technical performance advantages over conventional load path compensation techniques, such as passive crown mounted or inline compensators. The primary performance advantage of the AHD/A-CMC is its capability of minimizing WOB variation to as small as 10 kips in comparison to under 40 kips with a conventional passive compensator. The AHD/A-CMC does also have certain challenges to operation. First, it has a dependency on electrical (AHD)/hydraulic (A-CMC) energy as the prime mover. Second, software and controls that accompany the AHD/A-CMC are more complex.

Each active compensating draw-works has defined performance constraints, often supplied by the manufacturer. The location of this information supplied by the system provider will vary and at this time documentation is not consistent from one installation to the next, but is available. For a traditional draw-works operating from a stationary platform, such as a jack-up or land rig, the primary performance limitation is the required hookload. An active heave draw-works will use measured heave information from a sensor, such as a Motion/Vertical Reference Unit (MRU/VRU) or an encoder coupled to the riser or tensioners

### SUMMARY

In certain embodiments, software may be provided with an active heave compensation system that provides additional features to the active heave compensation system. In one embodiment, methods may include analyzing past logged variables and the active compensating draw-works performance curves to determine if the active compensating draw-works system was operated within the specified limits of the manufacturer. When troubleshooting past issues with the draw-works it is important to know and understand if the system was operating within its specific limits. This information will aid in identifying if the sea conditions exceeded the capabilities of the system and can be valuable information when having conversations with our customer.

In another embodiment, methods may analyze in near real-time to determine if the active compensating draw-works system is being operated within the specified limits of the manufacturer to attempt to improve the parameters or pause operations. With real-time compensation, the vessel also has an opportunity to improve the parameters to potentially optimize how the vessel is responding to the current sea state. This could be as simple as a heading change to increase the operations envelop of the draw-works. With this approach the alarm can be automated to notify the driller there is an issue, and based on a rule set and conditions generate recommended actions. If there is no practical method to improve vessel motion, the operations team could risk asses the operations to determine if heave compensation is critical for that phase and make the appropriate judgment call. Wave heights and rig heaves are shaped by statistics, and the software can produce probabilities that the rig will exceed a certain heave limit given the current measured sea state. This would be helpful in the risk assessment. For example, if the current significant vessel heave is 1 ft, it is highly unlikely the vessel will exceed 2.00 ft. However, if the vessel is heaving 1.5 ft, it is likely that the vessel will experience a heave greater than 2.00 ft. These are vague statements, but the active heave compensation software can use numbers to describe the likelihood instead.

According to another embodiment, software may predict if the system will be within or exceed the operational limits of the active compensating draw-works with predicted system inputs. This approach would have value when planning operations. By leveraging metocean predictions, well plan information (expected hook loads), vessel characteristics (RAOs) it can be determined (with some uncertainty) if the crew will be operating the draw-works outside of its specific limits. For critical operations, the performance curves single or multiple motor failures can also be integrated to evaluate the impact.

According to one embodiment, a method may include performing at least one or more of: receiving, by a processor, performance data associated with a marine motion-compensated draw-works system; receiving, by the processor, pre-defined performance specifications for the draw-works system; determining, by the processor, whether or not the performance of the draw-works system complies with the pre-defined performance specifications; and/or outputting, by the processor, a notification when the performance of the draw-works system is determined to not be in compliance with the pre-defined performance specifications.

The foregoing has outlined rather broadly certain features and technical advantages of embodiments of the present invention in order that the detailed description that follows may be better understood. Additional features and advantages will be described hereinafter that form the subject of the claims of the invention. It should be appreciated by those having ordinary skill in the art that the conception and specific embodiment disclosed may be readily utilized as a basis for modifying or designing other structures for carrying out the same or similar purposes. It should also be realized by those having ordinary skill in the art that such equivalent constructions do not depart from the spirit and scope of the invention as set forth in the appended claims. Additional features will be better understood from the following description when considered in connection with the accompanying figures. It is to be expressly understood, however, that each of the figures is provided for the purpose of illustration and description only and is not intended to limit the present invention.

### BRIEF DESCRIPTION OF THE DRAWINGS

For a more complete understanding of the disclosed system and methods, reference is now made to the following descriptions taken in conjunction with the accompanying drawings.

FIG. 1 is an illustration of a data flow for the real-time performance estimation of an active heave draw-works system according to one embodiment of the disclosure.

FIGS. 2A and 2B are illustrations of a TIN (triangular irregular network) as a mechanism to fit the digitized data to a surface according to one embodiment of the disclosure.

FIG. 3 is an illustration of a data flow for the real-time performance estimation of and active heave draw-works system according to one embodiment of the disclosure.

FIG. 4 is an example flow chart illustrating a method of identifying a marine motion-compensated draw-works system's performance with pre-defined performance specifications according to one embodiment of the disclosure.

### DETAILED DESCRIPTION

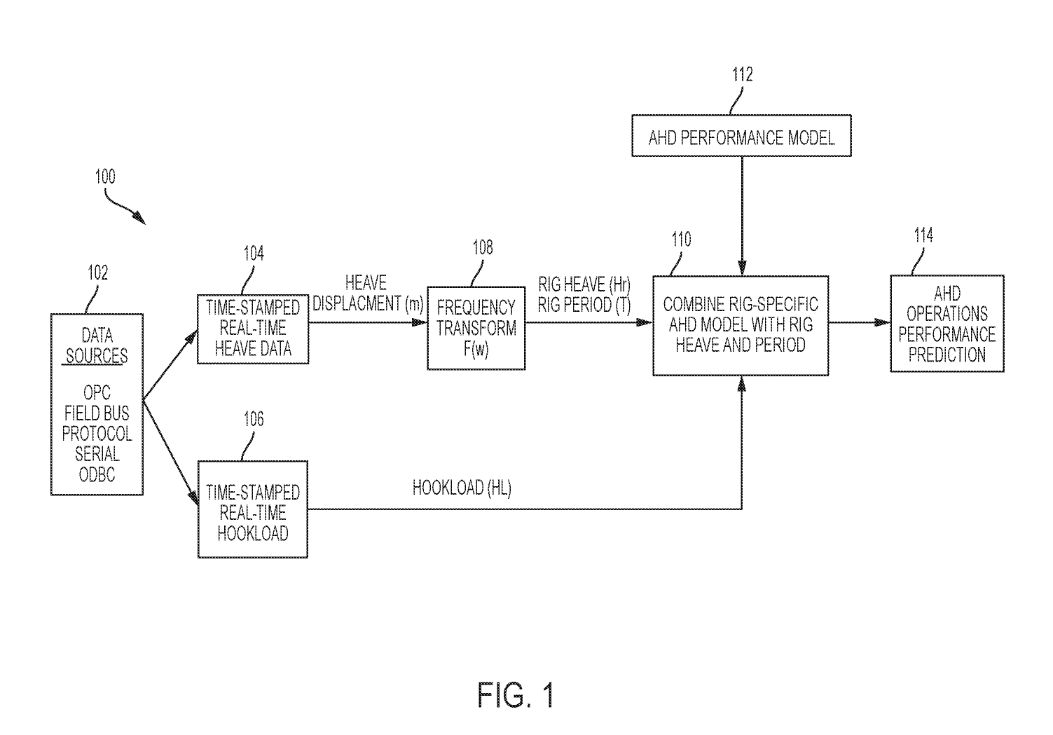

FIG. 1 is an illustration of a data flow for the real-time performance estimation of an active heave draw-works system according to one embodiment of the disclosure. A system 100 may include various hardware and/or software components that accomplish the data flow and processing illustrated in FIG. 1. The data flow begins at block 102 with data being produced by one or more data sources, such as data from a heave compensation system and/or hookload sensor. Data from block 102 is received and time-stamped at a recording device or a processor-based system as time-stamped, real-time heave data at block 104 and time-stamped real-time hookload measurements at block 106. The heave data at block 104 may include heave displacement information that is passed to a frequency-domain transform block 108, which may implement a Fast Fourier Transform (FFT) algorithm, and which outputs rig heave information and rig period information to block 110. At block 110, the rig heave and rig period are processed along with hookload information from block 104 and AHD performance model data from block 112. The AHD performance model may be recalled from storage during processing at block 110. The output of processing at block 110 may be an AHD operations performance prediction at block 114.

The processing at block 110, and consequently the output at block 114, may vary in different embodiments. For example, there are at least three times where analysis, such as that described above, can be used: post processing performance determination, real-time performance determination, and predictive performance determination. Each of these applications may result in a different processing block 110 to generate different output at block 114. For post-processing performance determination, an output at block 114 may include statistical data regarding adherence of certain actions to certain protocols and effectiveness of those actions in accomplishing a desired result. For real-time performance determination, the output at block 114 may include data regarding actions to take or recommendations for improving performance. For predictive performance determination, the output at block 114 may include instructions to modify operation of certain equipment to provide better performance.

First, performance estimation using the post-processing approach will be described. A model system limitation graph, such as a plot of heave amplitude at various hookloads, may be provided by a manufacturer with the system. However, the static plot of the resultant data may be leveraged instead. Rigs with active compensating draw-works can run a logging application to capture heave measurements and/or hookload. This data may be used in the post-processing approach or other approaches.

An example of a logged data set is below. The data may be time stamped and include both the heave sensor displacement value (MruPos in meters) as well as the Hookload (in Newtons).
Measurement time[hh:mm:ss]; MruPos [V]; BlockPosH [V]; PtbOn [V]; HookForce [V]; Fset [V]; Vffb [V]; BlockSpeedManFil [V]; SelHookload [V];
00:00:02,1;−0,13;3,62;0,00;2433373,25;2404339,75;−0,00;−0,04;247,77;
00:00:02,2;−0,13;3,61;0,00;2432856,75;2404339,75;−0,00;−0,04;247,74;
00:00:02,3;−0,15;3,59;0,00;2432503,00;2404339,75;−0,00;−0,04;247,71;

The data set listed above is only one realization of how the data is captured, as the actual data and format of the data may vary. The processing method described herein may include the ability to import different data formats (or capture real-time input) such that the observables can be brought into a normalized structure in the processing software.

Once the data is imported, it may be converted to a time series. To be able to establish the wave periods the vessel is experiencing, the time series data may be converted into the frequency domain. A Fourier transform or other transform/algorithm can be used to accomplish this transform. In one embodiment, a specialized version of the Fourier transform may be applied: the Short Time Fourier Transform (STFT).

Performing the frequency analysis alone may not be sufficient to determine the AHD system is operating within the manufacturer's specifications. The hookload is just as significant when determining if the active compensating draw-works is being operated within its capabilities. Next, the real-time information may be integrated with manufacturer supplied performance specifications of the AHD system. A sample performance curve is provided in Table 1.

TABLE 1
Digitized and scaled values for an example AHD capacity plot

| 8 Second period | | 12 Second period | | 16 Second period | |
|---|---|---|---|---|---|
| Hookload (mT) | | Hookload (mT) | | Hookload (mT) | |
| RigHeave (m) | | RigHeave (m) | | RigHeave (m) | |
| 48.713676 | 0.8248548 | 49.94822 | 1.8457065 | 50.07511 | 3.284217 |
| 149.59906 | 2.752906 | 110.84277 | 4.526425 | 88.684044 | 6.3274007 |
| 430.5181 | 2.1431408 | 537.0318 | 3.0037773 | 249.39972 | 5.3584757 |
| 599.8256 | 1.2668238 | 749.1578 | 0.9942178 | 327.76614 | 5.0039897 |
| 747.98303 | 0.65085804 | | | 577.7406 | 3.9030638 |
| | | | | 748.6322 | 1.5232316 |

The Short Time Fourier transformation can be selected to any value. Frequencies below 0.03 Hz may be ignored after the transform when tidal variations in the heave data are not expected. Also, looking at the SFT data for this data set, it may be determined that there is not a significant contribution beyond 0.2 Hz. Using this spectrum to focus the evaluation the key metrics to correlate with performance curves may include dominant frequencies, dominant amplitudes, and/or maximum Hookloads observed at these times. Further, alternative position displacement measuring techniques can be used to augment or replace the MRU, such as wireline optical rotary encoder assemble connected to the slipjoint so as to measure vessel motion with respect to the riser.

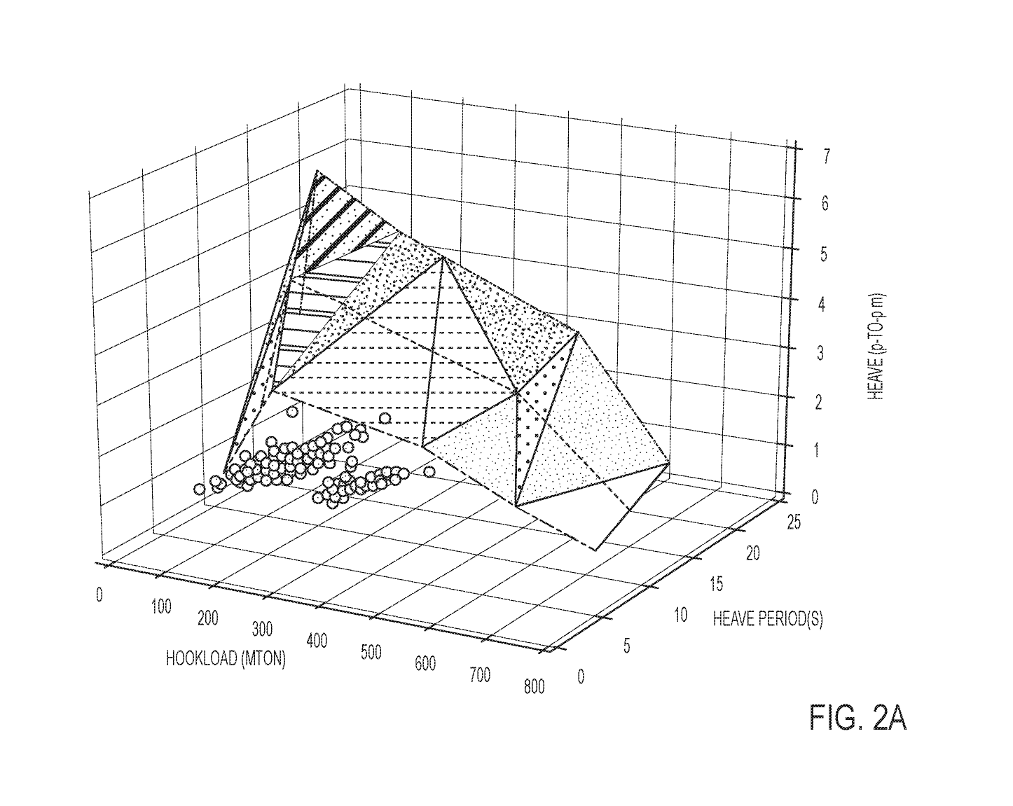

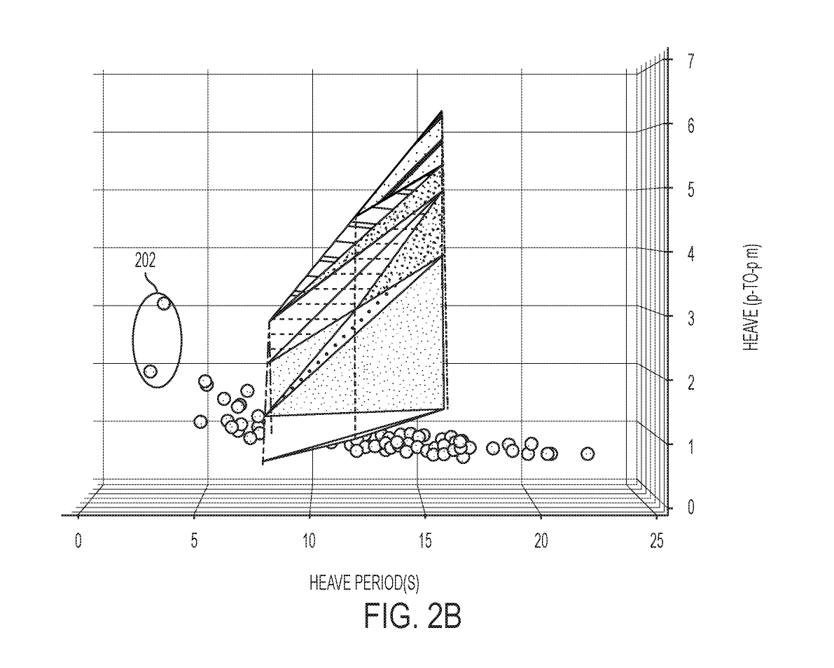

By combining the digitized values from the manufacturer's performance specification and fitting this to a surface the data can visualize and calculate if the particular time series data falls within specified performance limits of the system. FIG. 2A illustrates the use of a simple TIN (triangular irregular network) as a mechanism to fit the digitized data to a surface. Each data point (dot) in FIG. 2A represents the peak heave, hookload, and period for a specific time interval. With a mathematical model to replace the digitized data, the accuracy and extents of the systems displayed capabilities can be further improved. What can be accomplished by visual analysis can readily be accomplished through an automated process for all three realizations of this approach including 1) post-processing, 2) real-time processing, and predictive processing. FIG. 2B shows how the analysis can be used to determine that certain points 202 exceed the system's performance capabilities.

Post-processing is described above, but the model may alternatively or additionally perform real-time estimation. Performing these calculations in near real-time may be performed, for example, on a programmable logic controller (PLC) or a dedicated processor running this task either on a personal computer (PC) or MCU. Further, this can be implemented as a real-time web based tool such as by integrating it into the DARIC or equivalent application.

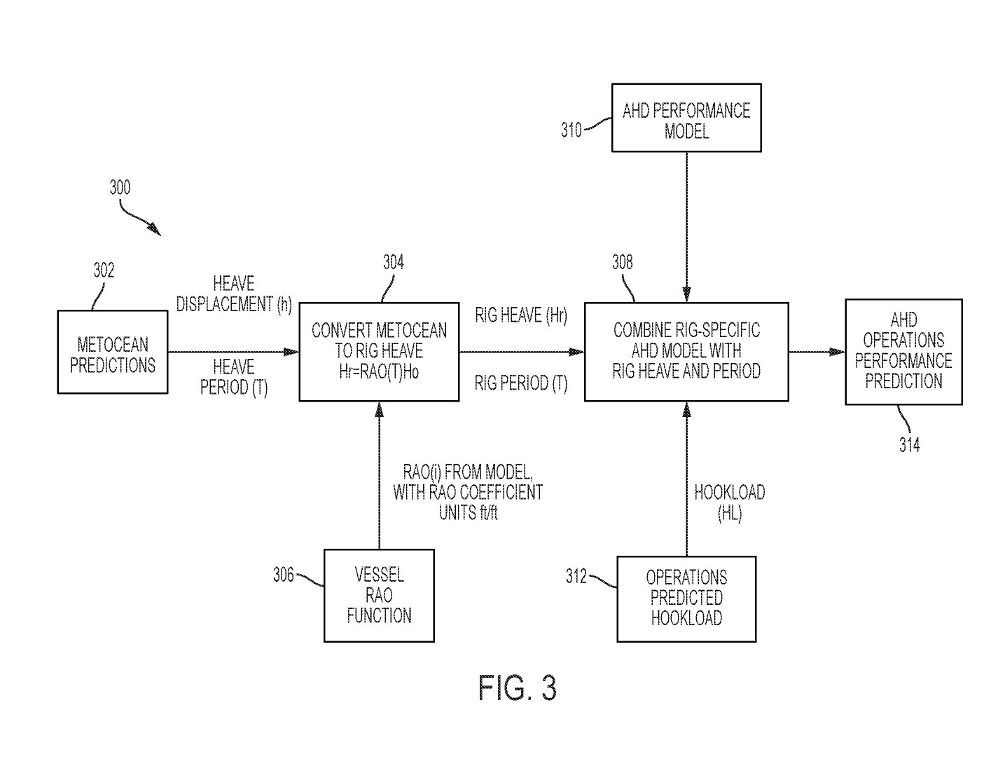

Further, the model may also provide for prediction analysis. The heave values obtained through prediction are that of the ocean itself and then an estimate of the effect it will have on the vessel may be computed. A predictive model may include generating the predicted rig heave from metocean condition information. For the purposes of this process using the first order estimation by applying the response amplitude operator (RAO) for a given wave period to the predicted wave height (as illustrated in FIG. 3).

FIG. 3 is an illustration of a data flow for the real-time performance estimation of an active heave draw-works system according to one embodiment of the disclosure. A system 300 may include various hardware and/or software components that accomplish the data flow and processing illustrated in FIG. 3. The data flow begins at block 302 with a data source for metocean predictions. The metocean predictions may include heave displacement and heave period provided to block 304, which converts metocean data to rig heave data using data from block 306 regarding vessel RAO function. Block 306 may provide to block 304 data including RAO(i) from a model, and RAO coefficient units. The rig heave data generated at block 304 may include rig heave and rig period, which are provided to block 308. At block 308, a rig-specific AHD model, received from AHD performance model block 310, may be combined with the rig heave and rig period from block 306 and/or hookload data received from operations predicted hookload block 312. The result of the combined data at block 308 may be output AHD operations performance prediction at block 314.

Another approach, which may be more accurate but involves more computational power, is evaluating the statistical motions of the vessel. This would provide the predicted rig heave and rig period. Rig operations then provide the maximum expected hookload to be seen by the draw-works in this model. It is then a matter of determining if the rig heave, rig period, and hookload observations fall within given AHD performance model limits or exceed them.

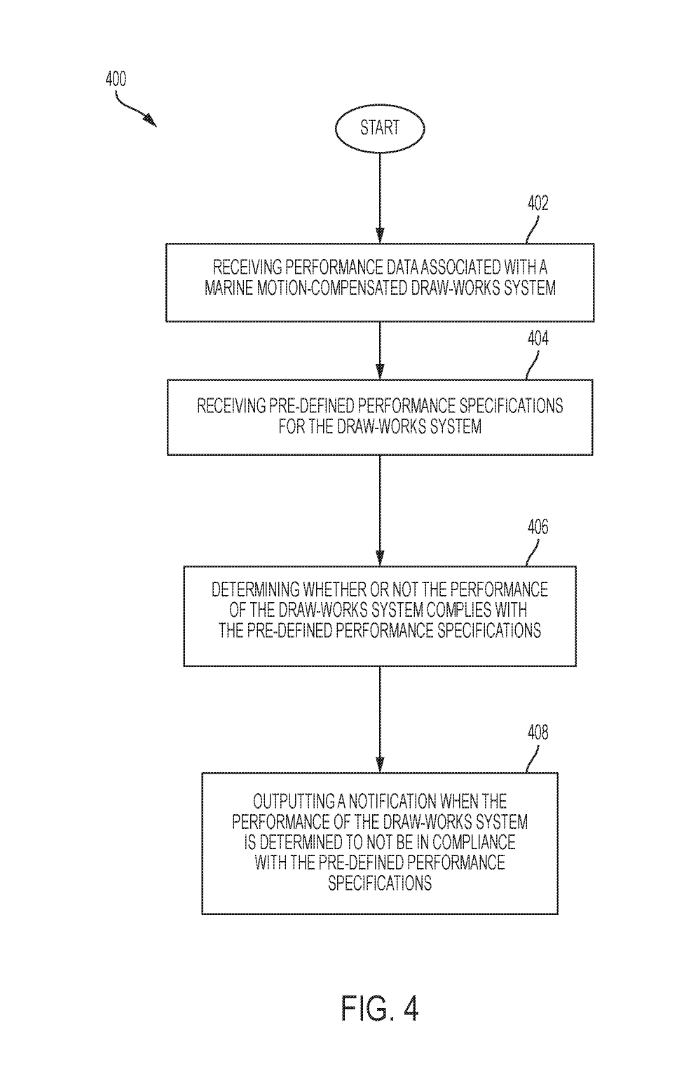

FIG. 4 is an example flow chart illustrating a method of identifying a marine motion-compensated draw-works system's performance with pre-defined performance specifications. A method 400 may begin at block 402 with receiving, by a processor, performance data associated with a marine motion-compensated draw-works system. Then, at block 404, the method 400 may include receiving, by the processor, pre-defined performance specifications for the draw-works system. Next, at block 406, the method 400 may include determining, by the processor, whether or not the performance of the draw-works system complies with the pre-defined performance specifications. Then, at block 408, the method 400 may include outputting, by the processor, a notification when the performance of the draw-works system is determined to not be in compliance with the pre-defined performance specifications.

The schematic flow chart diagram of FIG. 4 and the data flow of systems of FIG. 1 and FIG. 3 are generally set forth as a logical flow chart diagram. As such, the depicted order and labeled steps are indicative of aspects of the disclosed method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagram, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

If implemented in firmware and/or software, functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise random access memory (RAM), read-only memory (ROM), electrically-erasable programmable read-only memory (EEPROM), compact disc read-only memory (CD-ROM) or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and Blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and certain representative advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A method for identifying compliance of a marine motion-compensated draw-works system's performance with pre-defined performance specifications, comprising:
receiving, by a processor, performance data associated with a marine motion-compensated draw-works system;
receiving, by the processor, pre-defined performance specifications for the draw-works system;
determining, by the processor, whether or not the performance of the draw-works system complies with the pre-defined performance specifications; and
outputting, by the processor, a notification when the performance of the draw-works system is determined to not be in compliance with the pre-defined performance specifications.

2. The method of claim 1, further comprising adjusting operation of the draw-works system when the performance of the draw-works system is determined to not be in compliance with the pre-defined performance specifications.

3. The method of claim 1, wherein determining comprises:
converting the received performance data associated with the draw-works system to time series data; and
converting the time series data to frequency domain data, wherein the step of determining is performed based, at least in part, on the frequency domain data.

4. The method of claim 1, wherein the performance data associated with the draw-works system corresponds to past performance of the draw-works system, and receiving performance data comprises receiving logged performance data.

5. The method of claim 1, wherein the performance data associated with the draw-works system corresponds to current performance of the draw-works system, and receiving performance data comprises receiving real-time performance data.

6. The method of claim 1, wherein the performance data associated with the draw-works system corresponds to future performance of the draw-works system, and receiving performance data comprises receiving predictive performance data.

7. The method of claim 6, wherein the predictive performance data is determined by statistical analysis of the operation of the draw-works system and the environment of the draw-works system.

8. A computer program product, comprising:
a non-transitory computer readable medium comprising code to perform steps comprising:
receiving, by a processor, performance data associated with a marine motion-compensated draw-works system;
receiving, by the processor, pre-defined performance specifications for the draw-works system;
determining, by the processor, whether or not the performance of the draw-works system complies with the pre-defined performance specifications; and
outputting, by the processor, a notification when the performance of the draw-works system is determined to not be in compliance with the pre-defined performance specifications.

9. The computer program product of claim 8, wherein the medium further comprises code to perform steps comprising adjusting operation of the draw-works system when the performance of the draw-works system is determined to not be in compliance with the pre-defined performance specifications.

10. The computer program product of claim 8, wherein the step of determining comprises:
converting the received performance data associated with the draw-works system to time series data; and
converting the time series data to frequency domain data, wherein the step of determining is performed based, at least in part, on the frequency domain data.

11. The computer program product of claim 8, wherein the performance data associated with the draw-works system corresponds to past performance of the draw-works system, and receiving performance data comprises receiving logged performance data.

12. The computer program product of claim 8, wherein the performance data associated with the draw-works system corresponds to current performance of the draw-works system, and receiving performance data comprises receiving real-time performance data.

13. The computer program product of claim 8, wherein the performance data associated with the draw-works system corresponds to future performance of the draw-works system, and receiving performance data comprises receiving predictive performance data

14. The computer program product of claim 13, wherein the predictive performance data is determined by statistical analysis of the operation of the draw-works system and the environment of the draw-works system.

15. An apparatus, comprising:
a memory; and
a processor coupled to the memory and configured to perform steps comprising:
receiving, by a processor, performance data associated with a marine motion-compensated draw-works system;
receiving, by the processor, pre-defined performance specifications for the draw-works system;
determining, by the processor, whether or not the performance of the draw-works system complies with the pre-defined performance specifications; and
outputting, by the processor, a notification when the performance of the draw-works system is determined to not be in compliance with the pre-defined performance specifications.

16. The apparatus of claim 15, wherein the processor is further configured to perform steps comprising adjusting operation of the draw-works system when the performance of the draw-works system is determined to not be in compliance with the pre-defined performance specifications.

17. The apparatus of claim 15, wherein the step of determining comprises:
converting the received performance data associated with the draw-works system to time series data; and
converting the time series data to frequency domain data, wherein the step of determining is performed based, at least in part, on the frequency domain data.

18. The apparatus of claim 15, wherein the performance data associated with the draw-works system corresponds to past performance of the draw-works system, and receiving performance data comprises receiving logged performance data.

19. The apparatus of claim 15, wherein the performance data associated with the draw-works system corresponds to current performance of the draw-works system, and receiving performance data comprises receiving real-time performance data.

20. The apparatus of claim 15, wherein the performance data associated with the draw-works system corresponds to future performance of the draw-works system, and receiving performance data comprises receiving predictive performance data.

21. The apparatus of claim 20, wherein the predictive performance data is determined by statistical analysis of the operation of the draw-works system and the environment of the draw-works system.
